(19) United States
(12) Patent Application Publication
(10) Pub. No.: US 2017/0182924 A1
(43) Pub. Date: Jun. 29, 2017

(54) MODULAR CONFIGURABLE AUTOMATED GUIDED VEHICLE

(71) Applicants: Joseph T. Lendo, Rochester Hills, MI (US); Richard Standen, Grosse Ile, MI (US); Parashar Patel, Clinton Township, MI (US)

(72) Inventors: Joseph T. Lendo, Rochester Hills, MI (US); Richard Standen, Grosse Ile, MI (US); Parashar Patel, Clinton Township, MI (US)

(21) Appl. No.: 14/844,364

(22) Filed: Sep. 3, 2015

(51) Int. Cl. B60P 3/06; B60K 1/02; B60K 1/04; H02J 7/00; G08G 1/16; B60L 11/18; H02J 7/02; B60R 16/02; G05D 1/00

(52) U.S. Cl. CPC B60P 3/06; B60R 16/0215; B60K 1/02; B60K 1/04; G05D 1/0022; G08G 1/166; G08G 1/165; B60L 11/182; B60L 11/1818; H02J 7/025; H02J 7/0027; G05D 1/0016; B60Q 9/00

(57) ABSTRACT

A modular configurable automated guided vehicle including a drive module, a battery module, a pin module, a cowl module, and a control module is described herein. The drive module includes a drive wheel and a motor. The battery module includes a battery. The pin module includes a pin and a pin actuator. The cowl module includes a bumper and a caster. The control module includes a subplate to which a plurality of electrical components are mounted. The drive module, the battery module, the pin module, the cowl module, and the control module are discrete pre-assembled units that mate with one another in a longitudinally abutting relationship to cooperatively form a support housing. Accordingly, the drive module, the battery module, the pin module, the cowl module, and the control module are easily replaced and are configured to be connected to one another in a variety of different customizable sequences.

### FIELD

The subject disclosure generally relates to automated guided vehicles (AGVs).

### BACKGROUND

This section provides background information related to the present disclosure and is not necessarily prior art.

Automated guided vehicles (frequently referred to as AGVs) have many uses. For example, automated guided vehicles are widely used in manufacturing facilities, where automated guided vehicles carry and/or tow a load of raw material, manufactured parts, assemblies, and waste material to different areas of the manufacturing facility. Historically, manufacturing facilities have used automated vehicles that operate on a rail-like track, which may or may not be level with the floor of the facility. While track operated automated vehicles are simple in construction, the cost of installing and maintaining the track typically offsets the simplicity of the automated vehicle itself. Tracks, regardless of whether they are floor level or not, are also disruptive to the operation of the manufacturing facility and are expensive to modify if route changes for the automated vehicles are desired. With the advent of automated guided vehicles, advanced guidance systems eliminated the need for rail-like tracks. Some guidance systems utilize magnetic and/or radio-frequency identification (RFID) readers that detect magnetic strips, magnetic paint, and/or RFID tags disposed on or near the floor of the manufacturing facility. Other guidance systems utilize highly detailed, pre-programmed routes and/or optical route recognition devices. Regardless of the type of guidance system used, such automated guided vehicles can be put into service without requiring extensive construction or remodeling of the manufacture facility. Additionally, such automated guided vehicles obviate the need for disruptive rail-like tracks and the route of the automated guide vehicle can be changed more easily and, in some cases, on-the-fly as the automated guide vehicle is operating.

Although other forms of propulsion are possible, most automated guided vehicles use one or more electric motors to drive one or more drive wheels. The electric motors and the drive wheels are mounted to a chassis along with other components. In some cases, the automated guided vehicle may receive continuous electrical power from an external power line or electric contact strip. In other cases, the automated guided vehicle may have an on-board power source, such as one or more batteries. Since automated guided vehicles often operate on the floor of manufacturing facilities were workers are also present, automated guided vehicles are often equipped with a collision detection assembly. The collision detection assembly detects when the automated guided vehicle is close to an object such as a worker, machinery, or a wall, allowing the automated guided vehicle to stop or correct its course accordingly. The design of the chassis is therefore specifically tailored to hold these various components. For example, the chassis may be designed to hold a particular number of batteries, giving the automated guided vehicle a pre-determined range between recharges. As a result, the chassis design limits the number of batteries that the automated guided vehicle can hold and therefore limits the ability to increase the range of the automated guided vehicle. Other features are also limited by the chassis design, such as the type and number of provisions that carry or tow the load of raw material, manufactured parts, assemblies, and/or waste material. Therefore, existing automated guided vehicles are not easily customized or modified to fit the particular needs of the customer.

### SUMMARY

This section provides a general summary of the disclosure, and is not a comprehensive disclosure of its full scope or all of its features.

In accordance with one aspect of the subject disclosure, a modular configurable automated guided vehicle is disclosed. The modular configurable automated guided vehicle generally includes a drive module, a first battery module, a first pin module, a first cowl module, and a control module. The drive module includes a drive wheel and a motor. The first battery module includes a battery. The first pin module includes a pin and a pin actuator. The first cowl module includes a bumper and a caster. Finally, the control module includes a subplate that supports a plurality of electrical components. The drive module, the first battery module, the first pin module, the first cowl module, and the control module are discrete pre-assembled units that mate with one another in a longitudinally abutting relationship to cooperatively form a support housing of the modular configurable automated guided vehicle. Accordingly, the drive module, the first battery module, the first pin module, the first cowl module, and the control module are easily replaced and are configured to be connected to one another in a variety of different customizable sequences.

In accordance with other aspects of the subject disclosure, the drive module includes a first group of components comprising the drive wheel, the motor, an axle, and a drive module wiring harness. The first battery module includes a second group of components comprising the battery, a battery connector, and a battery module wiring harness. The first pin module includes a third group of components comprising the pin, the pin actuator, and a pin module wiring harness. The first cowl module includes a fourth group of components comprising the bumper, the caster, a collision detection assembly, a cowl module wiring harness, and a microcontroller. The microcontroller has a graphic user interface, a processor, and memory. The control module includes a fifth group of components comprising the subplate, a control module wiring harness, and the plurality of electrical components, which include a control relay, a pin motor relay, a circuit breaker bus, a circuit breaker, a ground bus, and a motor controller.

Advantageously, the modular configurable automated guide vehicle disclosed herein can be customized at the manufacturer for the specific needs of a customer using the drive module, the first battery module, the first pin module, the first cowl module, and the control module as standardized building blocks to create a customized support housing of the modular configurable automated guide vehicle. Because the drive module, the first battery module, the first pin module, the first cowl module, and the control module are discrete pre-assembled units that mate with one another in a longitudinally abutting relationship, various different customizable sequences are possible, where the drive module, the first battery module, the first pin module, the first cowl module, and the control module may be assembled in a particular order to address a certain need. Additionally, different numbers of drive modules, battery modules, pin modules, cowl modules, and/or control modules may be used. For example, to increase the range of the modular configurable automated guide vehicle, two battery modules may be used. Similarly, it is possible for customers to upgrade or otherwise modify an existing modular configurable automated guide vehicle by changing the order of the modules, adding modules, and/or removing modules based on need. Finally, the modular design improves the serviceability of the modular configurable automated guide vehicle because if one module malfunctions, it can easily be removed and replaced with a new module.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a top perspective view of an exemplary modular configurable automated guided vehicle that is constructed in accordance with the subject disclosure where a first cowl module, a first battery module, a first pin module, a drive module, and a control module of the exemplary modular configurable automated guided vehicle are connected to one another in an assembled state;

FIG. 2 is an exploded perspective view of the exemplary modular configurable automated guided vehicle shown in FIG. 1 where the first cowl module, the first battery module, the first pin module, the drive module, and the control module of the exemplary modular configurable automated guided vehicle are separated and spaced apart from one another in a disassembled state;

FIG. 3 is a bottom perspective view of the exemplary modular configurable automated guided vehicle shown in FIG. 1;

FIG. 4 is a top elevation view of the exemplary modular configurable automated guided vehicle shown in FIG. 1;

FIG. 5 is a side cross-sectional view of the exemplary modular configurable automated guided vehicle shown in FIG. 4 taken along line 5-5;

FIG. 6 is a bottom elevation view of the exemplary modular configurable automated guided vehicle shown in FIG. 1;

FIG. 7 is a front elevation view of the exemplary modular configurable automated guided vehicle shown in FIG. 1;

FIG. 8 is a rear elevation view of the exemplary modular configurable automated guided vehicle shown in FIG. 1;

FIG. 9 is a top elevation view of a subplate that is installed in the control module of the exemplary configurable automated guided vehicle shown in FIG. 1 where an exemplary layout of a plurality of electrical components that are mounted to the subplate is illustrated;

FIG. 10 is a top perspective view of another exemplary modular configurable automated guided vehicle that is constructed in accordance with the subject disclosure where a trailing module has been added to the exemplary modular configurable automated guided vehicle shown in FIG. 1 at a location adjacent to the control module and opposite the drive module;

FIG. 11 is a top perspective view of another exemplary modular configurable automated guided vehicle that is constructed in accordance with the subject disclosure where a second pin module has been added to the exemplary modular configurable automated guided vehicle shown in FIG. 1 between the drive module and the control module and a second cowl module has been added to the exemplary modular configurable automated guided vehicle shown in FIG. 1 at a location adjacent to the control module and opposite the second pin module; and

FIG. 12 is a top perspective view of another exemplary modular configurable automated guided vehicle that is constructed in accordance with the subject disclosure where a second battery module has been added to the exemplary modular configurable automated guided vehicle shown in FIG. 1 between the first battery module and the first pin module.

### DETAILED DESCRIPTION

Referring to the Figures, wherein like numerals indicate corresponding parts throughout the several views, a modular configurable automated guided vehicle 20 (AGV) is disclosed. Although the modular configurable automated guided vehicle 20 may be adapted for use in a wide variety of different applications, one exemplary use of the modular configurable automated guided vehicle 20 disclosed herein is for towing a load frame (not shown) on a support surface 22 (FIG. 5). As one non-limiting example, the support surface 22 may be a floor of a manufacturing facility and the load frame may be used to carry raw material, manufactured parts, assemblies, and/or waste material. Accordingly, the modular configurable automated guided vehicle 20 may be used to tow the load frame and thus the raw material, manufactured parts, assemblies, and/or waste material to different areas of the manufacturing facility autonomously. In other words, the modular configurable automated guided vehicle 20 can navigate and traverse the support surface 22 on its own, without the aid of a human driver.

Example embodiments will now be described more fully with reference to the accompanying drawings. Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

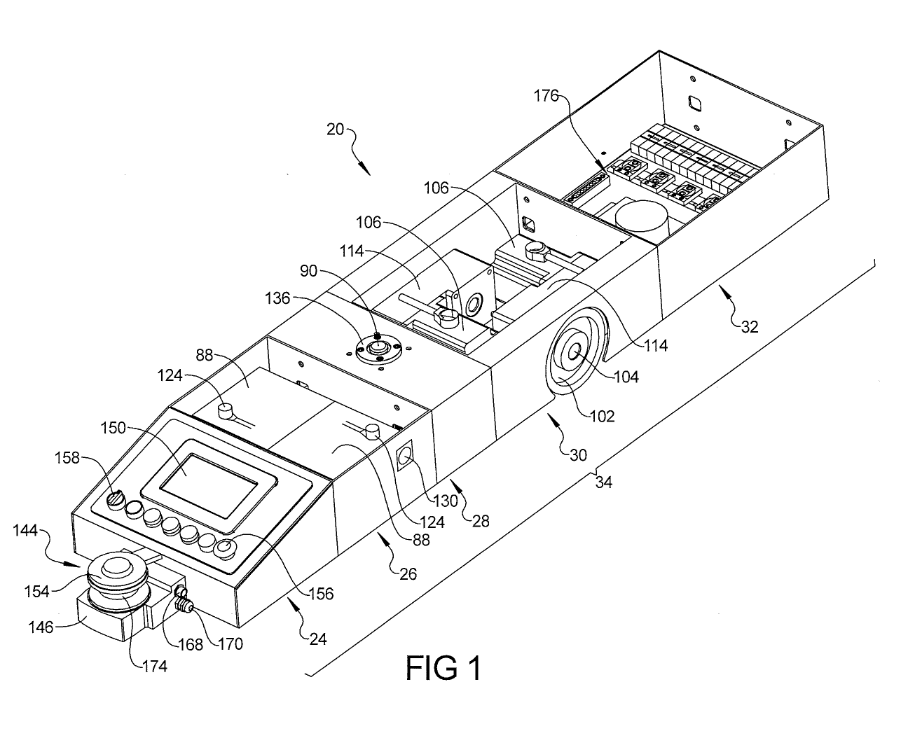

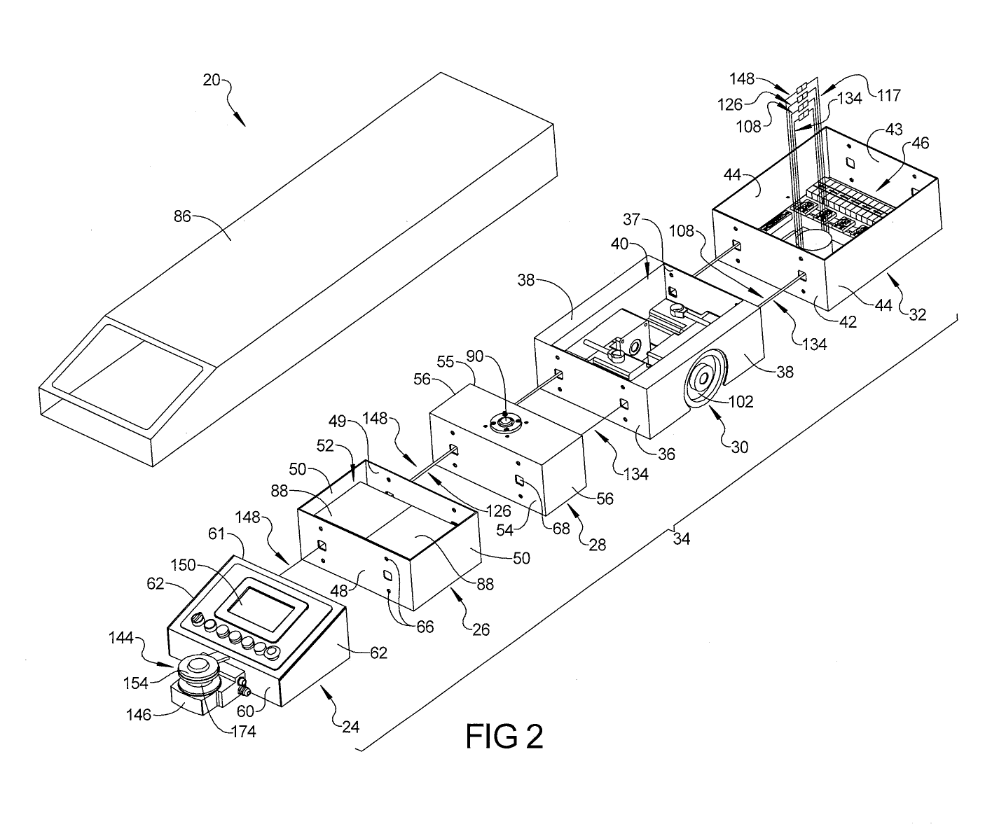

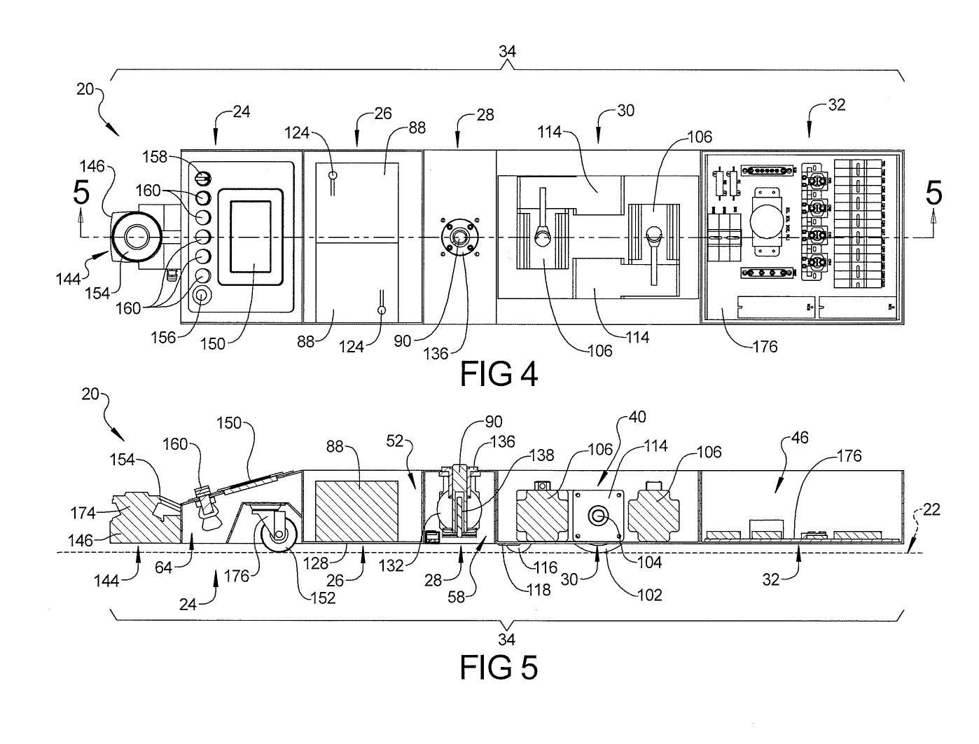

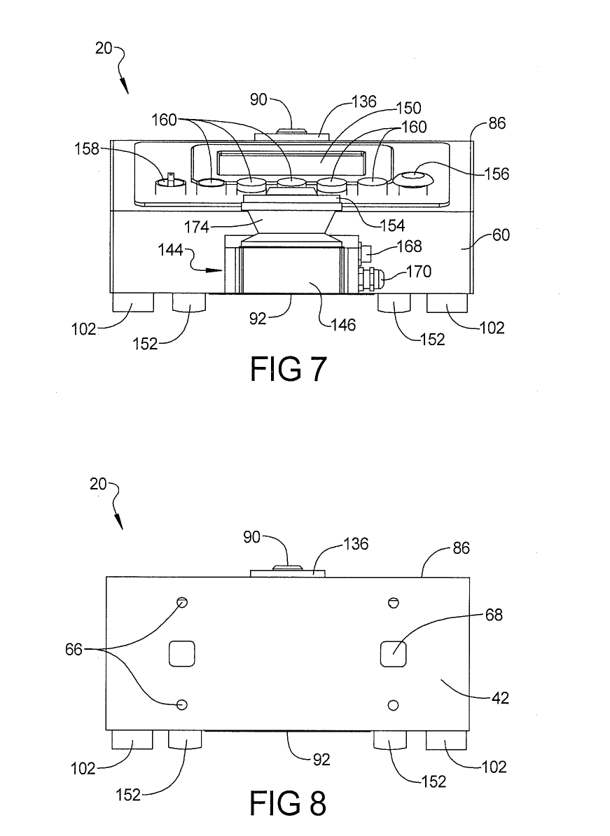

With reference to FIGS. 1-9, the modular configurable automated guided vehicle 20 is illustrated with five discrete modules. Sequentially, from left to right, these five discrete modules include a first cowl module 24, a first battery module 26, a first pin module 28, a drive module 30, and a control module 32. As will be explained in greater detail below, the first cowl module 24, the first battery module 26, the first pin module 28, the drive module 30, and the control module 32 are discrete, pre-assembled units that mate with one another in an abutting relationship to cooperatively form a support housing 34. Accordingly, the first cowl module 24, the first battery module 26, the first pin module 28, the drive module 30, and the control module 32 are easily replaced and are configured to be connected to one another in a variety of different customizable sequences. It should be appreciated that in FIG. 1, the modular configurable automated guided vehicle 20 is illustrated in an assembled state, where the first cowl module 24, the first battery module 26, the first pin module 28, the drive module 30, and the control module 32 are connected together in a string of modules. By contrast, in FIG. 2, the modular configurable automated guided vehicle 20 is illustrated in a disassembled state, where the first cowl module 24, the first battery module 26, the first pin module 28, the drive module 30, and the control module 32 are spaced longitudinally apart from one another.

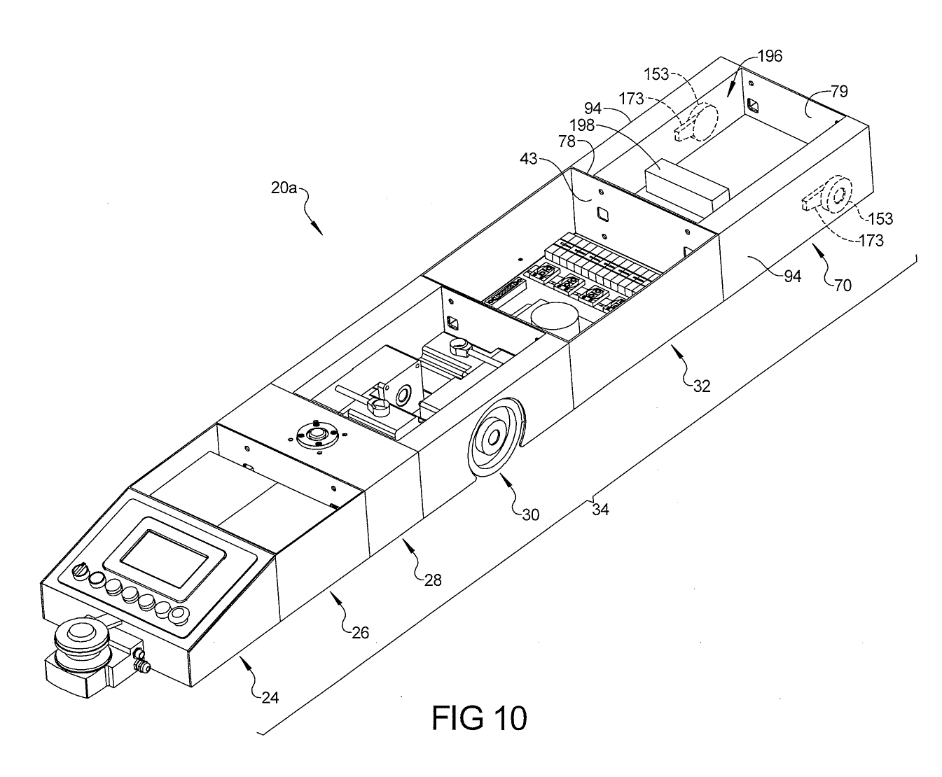

As will be discussed in greater detail below, FIGS. 10-12 illustrate some exemplary variations of the modular configurable automated guided vehicle 20 shown in FIGS. 1-9. Notwithstanding, it should be appreciated the order or sequence of the discrete modules may be modified from that shown in the Figures and described herein without departing from the scope of the subject disclosure. Additionally, the modular configurable automated guided vehicle 20 may be constructed with multiple ones of any particular module. Accordingly, the modular configurable automated guided vehicle 20 may be equipped with two or more of any of the modules shown in the Figures without departing from the scope of the subject disclosure.

Still referring to FIGS. 1-9, the discrete modules of the modular configurable automated guided vehicle 20 may be constructed in various forms. For example, the drive module 30 may have forward and aft drive module bulkheads 36, 37 that are longitudinally spaced apart from one another by drive module sides 38. The forward and aft drive module bulkheads 36, 37 and the drive module sides 38 therefore define a drive module compartment 40 therein. Similarly, the control module 32 may have forward and aft control module bulkheads 42, 43 that are longitudinally spaced apart from one another by control module sides 44. The forward and aft control module bulkheads 42, 43 and the control module sides 44 therefore define a control module compartment 46 therein. The first battery module 26 may have forward and aft first battery module bulkheads 48, 49 that are longitudinally spaced apart from one another by first battery module sides 50. The forward and aft first battery module bulkheads 48, 49 and the first battery module sides 50 therefore define a first battery module compartment 52 therein. The first pin module 28 may have forward and aft first pin module bulkheads 54, 55 that are longitudinally spaced apart from one another by first pin module sides 56. The forward and aft first pin module bulkheads 54, 55 and the first pin module sides 56 therefore define a first pin module compartment 58 therein. Finally, the first cowl module 24 may have forward and aft first cowl module bulkheads 60, 61 that are longitudinally spaced apart from one another by first cowl module sides 62. The forward and aft first cowl module bulkheads 60, 61 and the first cowl module sides 62 therefore define a first cowl module compartment 64 therein.

In the particular exemplary configuration shown in FIGS. 1-9, the first battery module 26 is arranged sequentially between the first cowl module 24 and the first pin module 28. The first pin module 28 is arranged sequentially between the first battery module 26 and the drive module 30. Finally, the drive module 30 is arranged sequentially between the first pin module 28 and the control module 32. Stated another way, the aft first cowl module bulkhead 61 is aligned with and is attached to the forward first battery module bulkhead 48 in a longitudinally abutting relationship. The aft first battery module bulkhead 49 is aligned with and is attached to the forward first pin module bulkhead 54 in a longitudinally abutting relationship. The aft first pin module bulkhead 55 is aligned with and is attached to the forward drive module bulkhead 36 in a longitudinally abutting relationship. Finally, the aft drive module bulkhead 37 is aligned with and is attached to the forward control module bulkhead 42 in a longitudinally abutting relationship. The aft first cowl module bulkhead 61, the forward and aft first battery module bulkheads 48, 49, the forward and aft first pin module bulkheads 54, 55, the forward and aft drive module bulkheads 36, 37, and the forward control module bulkhead 42 have substantially identical shapes and dimensions and have fastening holes 66 and wire routing openings 68 that are substantially identical in size, shape, and position. As a result of this symmetry, the drive module 30, the control module 32, the first battery module 26, the first pin module 28, and the first cowl module 24 mate with one another in a longitudinally abutting relationship, are easily replaced, and are configured to be connected to one another in a variety of different customizable arrangements.

In FIGS. 1-9, the forward first cowl module bulkhead 60 forms a front of the modular configurable automated guided vehicle 20 and the aft control module bulkhead 43 forms a rear of the modular configurable automated guided vehicle 20. Accordingly, the forward first cowl module bulkhead 60 and the aft control module bulkhead 43 may or may not have an identical shape and dimension to the aft first cowl module bulkhead 61, the forward and aft first battery module bulkheads 48, 49, the forward and aft first pin module bulkheads 54, 55, the forward and aft drive module bulkheads 36, 37, and the forward control module bulkhead 42. For example, the forward first cowl module bulkhead 60 shown in FIGS. 1-9 is smaller in dimension (e.g. is shorter) than the other bulkheads such that the first cowl module 24 of the modular configurable automated guided vehicle 20 slopes down like the hood of a car.

It should also be appreciated that although the bulkheads illustrated in FIGS. 1-9 are flat and rectangular, the bulkheads may alternatively be curved or contoured and may have a different shape so long as the aft first cowl module bulkhead 61, the forward and aft first battery module bulkheads 48, 49, the forward and aft first pin module bulkheads 54, 55, the forward and aft drive module bulkheads 36, 37, and the forward control module bulkhead 42 are complimentary to one other to permit the mating of the discrete modules. As shown in FIG. 2, the modular configurable automated guided vehicle 20 may optionally include a cover 86 that extends over all or part of the drive module 30, the control module 32, the first battery module 26, the first pin module 28, and the first cowl module 24. The cover 86 may be removable to make servicing and disassembly of the modular configurable automated guided vehicle 20 easier. Alternatively, each of the drive, control, first battery, first pin, and first cowl modules 24, 26, 28, 30, 32 may have a top (not shown) to eliminate the need for the cover 86 shown in FIG. 2. A number of different materials are suitable for the bulkheads and the sides of the discrete modules and the cover 86. By way of example and without limitation, various metals, metal alloys, plastics, and combinations thereof may be used.

The various components of the modular configurable automated guided vehicle 20 are mounted to and supported by the support housing 34. In some examples, where the modular configurable automated guided vehicle 20 lacks the cover 86 shown in FIG. 2, the support housing 34 forms a body of the modular configurable automated guided vehicle 20.

Still referring to FIGS. 1-9, the drive module 30 includes a first group of components comprising one or more drive wheels 102, axles 104, and motors 106 and a drive module wiring harness 108 (FIG. 2) that is electrically connected to the motors 106. The first group of components may further include one or more brake assemblies 110, traction spring assemblies 112, gearboxes 114, recovery wheels 116, recovery wheel deployment mechanisms 118, a drive module sensor assembly 120, and charge plates 122. The drive wheels 102 are rotatably coupled to the axles 104 and are configured to contact and roll along the support surface 22. The axles 104 are rotatably coupled to the brake assemblies 110 and the gearboxes 114. When engaged, the brake assemblies 110 slow and/or stop rotation of the axels and therefore slow and/or stop rotation of the drive wheels 102. Accordingly, application of the brake assemblies 110 together in equal amounts results in slowing down and eventually stopping the movement of the modular configurable automated guided vehicle 20. In accordance with one configuration, the application of the brake assemblies 110 in unequal amounts (e.g. applying only one of the brake assemblies 110) can be used to turn the modular configurable automated guided vehicle 20. The gearboxes 114 are rotatably coupled to the motors 106. The motors 106 drive rotation of the axles 104, and thus the drive wheels 102, through the gearboxes 114. When the motors 106 operate at the same time, in the same rotational direction, and at the same rotational speed, the motors 106 drive the modular configurable automated guided vehicle 20 in a straight line across the support surface 22 in either a forward direction or a reverse direction. When the motors 106 operate at unequal rotational speeds (e.g. operating only one of the motors 106 at a time), the motors 106 can be used to turn the modular configurable automated guided vehicle 20. When the motors 106 operate in opposite rotational directions, the motors 106 can be used to spin the modular configurable automated guided vehicle 20 in a tight turning circle. The motors 106 are disposed within the drive module compartment 40 and receive electricity from the drive module wiring harness 108. As such, the motors 106 illustrated in the Figures are electric motors. The drive module wiring harness 108 may receive electricity from an external power line (not shown) that supplies electricity to the modular configurable automated guided vehicle 20. Alternatively, the drive module wiring harness 108 may receive electricity from an on-board power source, such as one or more batteries 88 that are carried in the first battery module 26. Notwithstanding, it should be appreciated that the motors 106 may be any prime mover and are not limited to just electric motors.

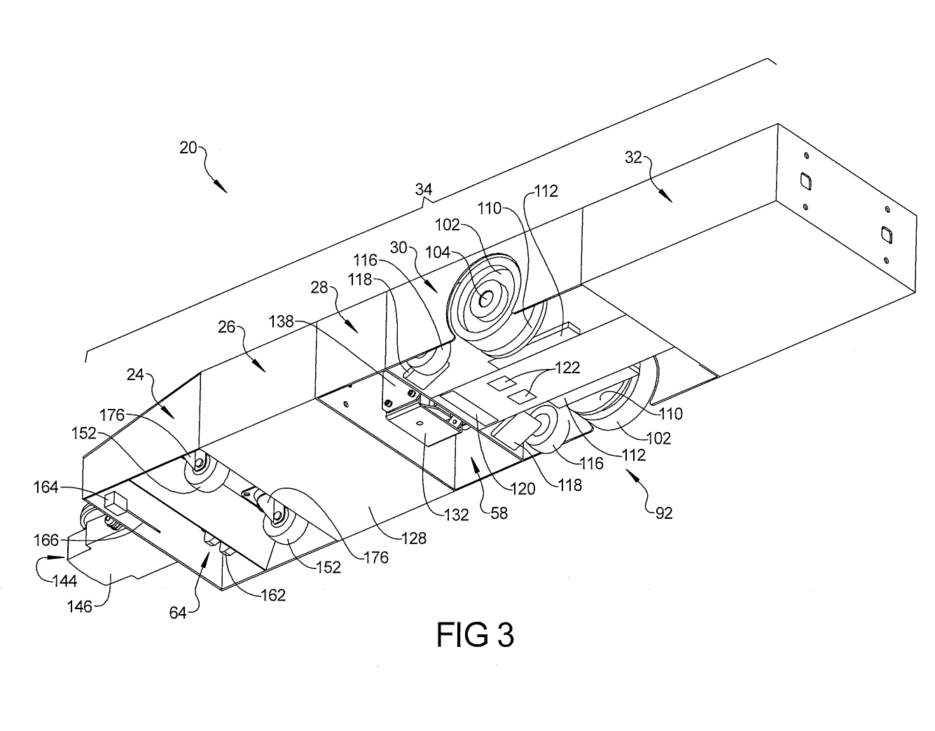

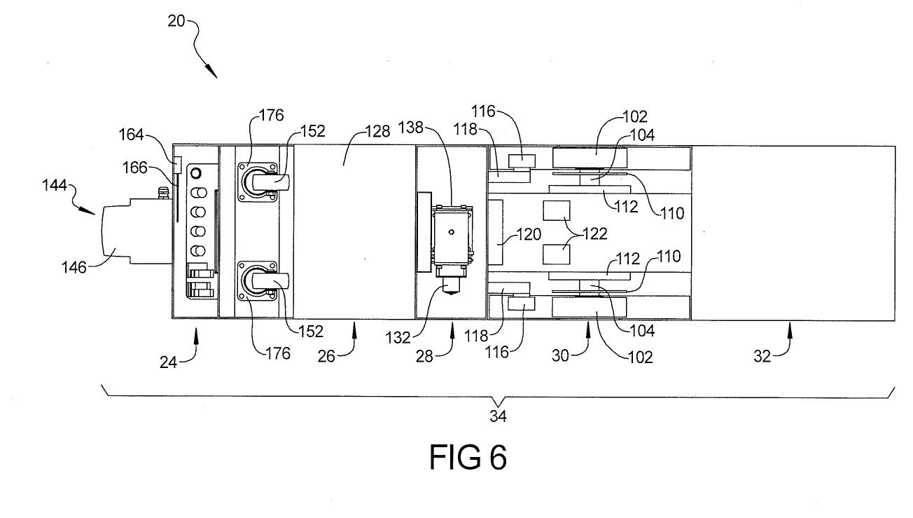

The drive module sensor assembly 120 (shown in FIGS. 3 and 6) may include a magnetic field sensor and/or a radio frequency ID sensor that are electrically connected to the drive module wiring harness 108. The magnetic field sensor of the drive module sensor assembly 120 helps to guide the modular configurable automated guided vehicle 20 by detecting magnetic strips (not shown) that are placed along or adjacent to the support surface 22. Similarly, the radio frequency ID sensor (i.e. RFID sensor) of the drive module sensor assembly 120 helps to guide the modular configurable automated guided vehicle 20 by detecting radio frequency ID tags (not shown) that are placed along or adjacent to the support surface 22. It should be appreciated that the magnetic strips and/or radio frequency ID tags may help the modular configurable automated guided vehicle 20 navigate across the support surface 22 and/or determine where the modular configurable automated guided vehicle 20 is scheduled to make a stop. For example and without limitation, the radio frequency ID tag may communicate with the radio frequency ID sensor of the drive module sensor assembly 120 to control whether the modular configurable automated guided vehicle 20 will stop at a given loading/unloading zone located on the support surface 22. Similarly, the radio frequency ID tag may communicate with the radio frequency ID sensor of the drive module sensor assembly 120 to control whether the modular configurable automated guided vehicle 20 will stop at a remote charging station (not shown), where the batteries 88 of the modular configurable automated guided vehicle 20 are recharged. To this end, the charge plates 122 (shown in FIGS. 3 and 6) on the drive module 30 are exposed to a bottom side 92 of the modular configurable automated guided vehicle 20 and are configured to contact and form an electrical charging connection with the remote charging station. The charge plates 122 are electrically connected to the drive module wiring harness 108 and are therefore electrically connected to the batteries 88.

The recovery wheels 116 (shown in FIGS. 3 and 6) are caster wheels that are supported by the recovery wheel deployment mechanisms 118. The recovery wheel deployment mechanisms 118 are swing arms or cam-like structures that operably pivot the recovery wheels 116 relative to the drive module 30 and the support surface 22. Accordingly, the recovery wheel deployment mechanisms 118 operates to lift the drive module 30 to a recovery position where the recovery wheels 116 extend down to contact the support surface 22 and lift the drive wheels 102 off the support surface 22. This allows the modular configurable automated guided vehicle 20 to easily be pushed or pulled along the support surface 22 by an external force (such as by a person) in the event the modular configurable automated guided vehicle 20 breaks down, becomes stuck, or runs out of electricity (i.e. if the batteries 88 are completely discharged). The traction spring assemblies 112 (shown in FIGS. 3 and 6) are suspension systems that moveably support the drive wheels 102 on the drive module 30. The traction spring assemblies 112 allow the drive wheels 102 to translate relative to the drive module 30, which helps the drive wheels 102 maintain contact with the support surface 22 as the modular configurable automated guided vehicle 20 traverses the support surface 22, even when the support surface 22 is uneven.

The first battery module 26 includes a second group of components comprising the one or more batteries 88, one or more battery connectors 124, and a battery module wiring harness 126 (FIG. 2). The second group of components may further include a battery tray 128 and an auxiliary charge port 130 (FIG. 1). The batteries 88 are received in the first battery module compartment 52 and are supported therein by the battery tray 128. The batteries 88 are electrically connected to the battery 88 module harness by the battery connectors 124. The batteries 88 provide electricity to the control module 32 via the battery module wiring harness 126. The control module 32 then supplies the electricity it receives from the batteries 88 to the rest of the modular configurable automated guided vehicle 20, including to the drive module 30, the first cowl module 24, and the first pin module 28. The auxiliary charge port 130 is electrically connected to the battery module wiring harness 126. The auxiliary charge port 130 operably connects to an external power line (not shown), which can supply electricity to the battery module wiring harness 126 for charging the batteries 88. Therefore, it should be appreciated that the batteries 88 can be charged by the modular configurable automated guided vehicle 20 receiving electricity through the charge plates 122 fitted to the drive module 30 (i.e. drive up docking) or by receiving electricity through the auxiliary charge port 130 (i.e. plug-in charging).

The first pin module 28 includes a third group of components comprising a pin 90, a pin actuator 132, and a pin module wiring harness 134 (FIG. 2). The third group of components may further include a bearing assembly 136, a pin support frame 138, a pin position sensor (not shown), and at least one limit switch (not shown). The pin 90 is slidingly supported by the bearing assembly 136 for linear movement between a retracted position and an extended position. The pin actuator 132 includes a spring and an electric motor that is connected to an associated gearbox. The pin actuator 132 operably drives linear movement of the pin 90 between the extended position and the retracted position. The pin 90 operably engages the load frame in the extended position and sits flush with the bearing assembly 136 in the retracted position. The electric motor of the pin actuator 132, the pin position sensor, and the at least one limit switch are electrically connected to the pin module wiring harness 134 and together control the movement of the pin 90. Of course other types of pin actuators may be used in place of the electric actuator disclosed, including without limitation, pneumatic, hydraulic, and magnetic actuators. The bearing assembly 136 and the pin actuator 132 are attached to and supported on the first pin module 28 by the pin support frame 138. Accordingly, the loads applied to the pin 90 as a result of towing the load frame are transferred to the forward and aft first pin module bulkheads 54, 55 and the first pin module sides 56, via the pin support frame 138. It should be appreciated that in accordance with certain embodiments of the subject disclosure, the modular configurable automated guided vehicle 20 is configured as a tunneling, tugger-style automated guided vehicle. This means that the modular configurable automated guided vehicle 20 has an overall size and shape that allows it to drive under the load frame (i.e. tunnel). When the modular configurable automated guided vehicle 20 is positioned beneath the load frame, the pin actuator 132 extends the pin 90 to the extended position to engage the load frame. The modular configurable automated guided vehicle 20 then drives away, towing the load frame. To release the load frame, the pin actuator 132 retracts the pin 90 to the retracted position such that the pin 90 no longer is in engagement with the load frame and the modular configurable automated guided vehicle 20 then simply drives out from under the load frame.

The first cowl module 24 includes a fourth group of components comprising a collision detection assembly 144, a bumper 146, a cowl module wiring harness 148 (FIG. 2), a microcontroller 150, and one or more casters 152. The fourth group of components may further include a sensor guard 154, an emergency stop switch 156, a mode select switch 158, a plurality of indicator lights 160, an audible warning sounder 162, a wireless communications unit 164, an antenna 166, a digital input connector 168, a digital output connector 170, and one or more caster mounts 172. The collision detection assembly 144 operably detects collisions and/or impending collisions between the modular configurable automated guided vehicle 20 and a foreign object. By way of example and without limitation, the collision detection assembly 144 may include a laser sensor 174 for collision detection. The laser sensor 174 of the collision detection assembly 144 is electrically connected to the cowl module wiring harness 148, which supplies the laser sensor 174 with electricity and receives electrical signals from the laser sensor 174 that are indicative of detected objects.

The collision detection assembly 144 may be mounted to the forward first cowl module bulkhead 60 such that the collision detection assembly 144 is positioned outside the first cowl module compartment 64. The bumper 146 extends outwardly from the forward first cowl module bulkhead 60 and about the collision detection assembly 144. In this way, the bumper 146 helps protect the collision detection assembly 144. Similarly, the sensor guard 154 helps protect the laser sensor 174 by extending outwardly from the forward first cowl module bulkhead 60 to a position above the laser sensor 174. The casters 152 may be swivel casters or fixed casters. The casters 152 contact the support surface 22 and therefore help support the modular configurable automated guided vehicle 20 on the support surface 22 in conjunction with the drive wheels 102 of the drive module 30. The caster mounts 172 are attached to the aft first cowl module bulkhead 61 and support the casters 152 on the first cowl module 24. In addition to being connected to the laser sensor 174, the cowl module wiring harness 148 is electrically connected to the emergency stop switch 156, the mode select switch 158, the plurality of indicator lights 160, the audible warning sounder 162, the wireless communications unit 164, the antenna 166, the digital input connector 168, the digital output connector 170, and the microcontroller 150.

The cowl module wiring harness 148 supplies electricity to these components and carries electrical signals from the components to the control module 32. As such, the emergency stop switch 156 operably stops the modular configurable automated guided vehicle 20 when the emergency stop switch 156 is depressed. The mode select switch 158 operably switches the modular configurable automated guided vehicle 20 between different operating modes, including for example [client should insert]. The plurality of indicator lights 160 illuminate to identify certain operating conditions of the modular configurable automated guided vehicle 20. By way of example and without limitation, one or more of the indicator lights 160 may illuminate when one or more of the following operating conditions exist [client should insert]. The audible warning sounder 162 operably sounds an audible alarm when certain operating conditions exist, such as when [client should insert]. The microcontroller 150 may include a graphic user interface, a processor, and memory. The graphic user interface of the microcontroller 150, which may be a liquid crystal display (LCD), displays various operating conditions and functions of the modular configurable automated guided vehicle 20. By way of non-limiting example, some of these operating conditions and functions may include [client should insert]. The microcontroller 150 also allows users to change certain setting of the modular configurable automated guided vehicle 20, including without limitation, [client should insert] The wireless communications unit 164 and the antenna 166 (FIGS. 3 and 6) allow the microcontroller 150 to wirelessly communicate with a remote electronic device, such as, for example, a computer, smart phone, or tablet. This allows users to remotely view and control the graphic user interface of the microcontroller 150. The digital input connector 168 and the digital output connector 170 allow the microcontroller 150 of the modular configurable automated guided vehicle 20 to be electrically connected to the remote electronic device by an external wire. This can be done to view diagnostics, error codes, and to upload updates to the software stored in the memory of the microcontroller 150. It should be appreciated that although the digital input connector 168 and the digital output connector 170 are illustrated in the Figures as separate, spaced apart elements, the digital input connector 168 and the digital output connector 170 may be combined into a single digital connector.

The control module 32 includes a fifth group of components comprising a subplate 176 having a plurality of electrical components mounted thereon and a control module wiring harness 177 (FIG. 2). One end of the control module wiring harness 177 may be electrically connected to the subplate 176. As shown in FIG. 2, the other end of the control module wiring harness 177 may be electrically connected to the drive module wiring harness 108, the battery module wiring harness 126, the pin module wiring harness 134, and the cowl module wiring harness 148. In this way, the drive module wiring harness 108, the battery module wiring harness 126, the pin module wiring harness 134, and the cowl module wiring harness 148 are all electrically connected to the subplate 176 via the control module wiring harness 177. It should be appreciated that in FIG. 2, the drive module wiring harness 108, the battery module wiring harness 126, the pin module wiring harness 134, the cowl module wiring harness 148, and the control module wiring harness 177 have been extended for illustration purposes. Therefore, this view does not represent how the modular configurable automated guided vehicle 20 would look in the assembled state.

The drive module wiring harness 108, the battery module wiring harness 126, the pin module wiring harness 134, and the cowl module wiring harness 148 may have unique pin connectors. Each of the unique pin connectors has a unique number of pins to improve ease of assembly and to reduce electrical wiring errors. In other words, there will be only one way that the drive module wiring harness 108, the battery module wiring harness 126, the pin module wiring harness 134, and the cowl module wiring harness 148 can be plugged in to the control module wiring harness 177, which prevents wiring errors. For example, the unique connectors would prevent the battery module wiring harness 126 from being inadvertently plugged into the connector of the control module wiring harness 177 where the drive module wiring harness 108 is supposed to be connected.

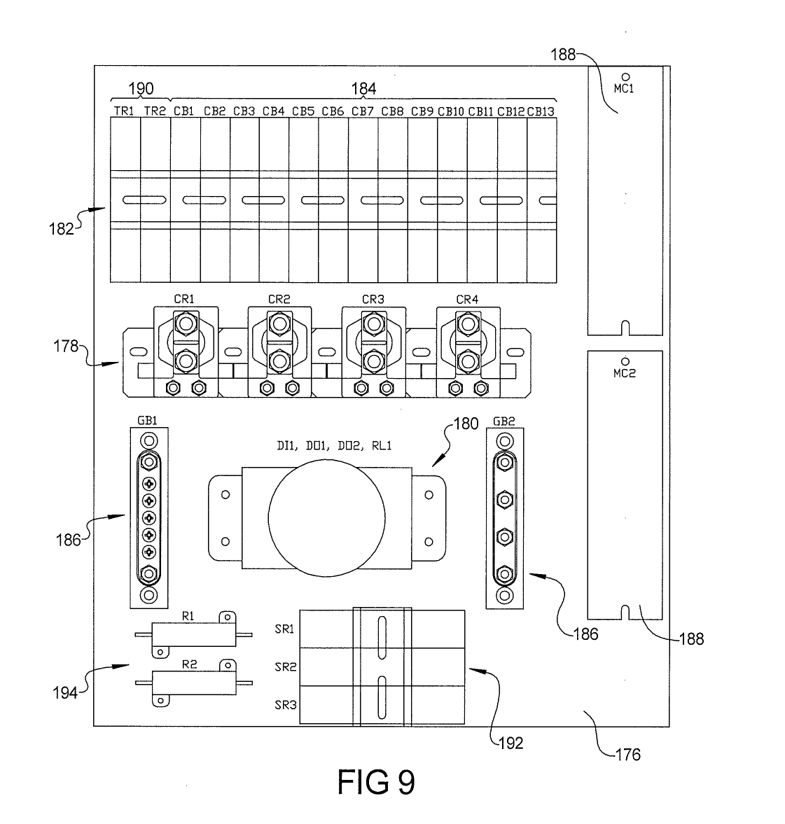

With reference to FIG. 9, the plurality of electrical components mounted on the subplate 176 include one or more control relays 178, pin motor relays 180, circuit breaker buses 182, circuit breakers 184, ground buses 186, and motor controllers 188. The plurality of electrical components mounted on the subplate 176 may further include one or more timer relays 190, safety relays 192, and pre-charge resistors 194. The control relays 178 selectively supply electricity to the microcontroller 150 to power the microcontroller 150 on and off. The pin motor relays 180 selectively supply electricity to the electric motor of the pin actuator 132 to control movement of the pin 90 between the extended position and the retracted position. The circuit breaker buses 182 and the ground buses 186 handle electricity flowing to and from the subplate 176 from the batteries 88 of the first battery module 26. The circuit breakers 184 are mounted on the circuit breaker bus 182 and provide overload protection to the electrical components of the modular configurable automated guided vehicle 20 in the event of current and/or voltage spikes. The motor controllers 188 selectively supply and regulate the electricity flowing to the motors 106 of the drive module 30 to control movement of the modular configurable automated guided vehicle 20 relative to the support surface 22. The timer relays 190 allow electricity to flow to the pre-charge resistors 194 first, before flowing to the control relays 178. This allows the microcontroller 150 to power down gradually to prevent damage to the microcontroller 150. Finally, the safety relays 192 are electrically connected to the laser sensor 174 of the collision detection assembly 144 and the emergency stop switch 156 and selectively stop the flow of electricity to the motors 106 of the drive module 30 in the event the laser sensor 174 detects a collision or an impending collision with a foreign object or in the event the emergency stop switch 156 is depressed.

It should be appreciated that the groups of components found within each of the discrete modules were carefully selected and grouped together such that discrete pre-assembled units of the modular configurable automated guided vehicle 20 could be formed. Because of the components that were selected to be in each of the groups of components, the discrete modules can be tested individually as a standalone unit before the various discrete modules are assembled to form the support housing 34 of the modular configurable automated guided vehicle 20. If the components of the automated guided vehicle were not grouped according to the present teachings and discrete modules could not be pre-tested without being connected to other modules and, the automated guided vehicle would not be able to have the modular configurable design disclosed herein.

With reference to FIG. 10, another configuration of the modular configurable automated guided vehicle 20a is illustrated where a trailing module 70 has been added to the modular configurable automated guided vehicle 20 shown in FIGS. 1-9. The trailing module 70 may have forward and aft trailing module bulkheads 78, 79 that are longitudinally spaced apart from one another by trailing module sides 94. The forward and aft trailing module bulkheads 78, 79 and the trailing module sides 94 therefore define a trailing module compartment 196 therein. The trailing module 70 is positioned in an end-to-end abutting relationship with the control module 32 and is attached to the control module 32 opposite the drive module 30. In other words, the forward trailing module bulkhead 78 is connected to the aft control module bulkhead 43 in a longitudinally abutting relationship. The trailing module 70 includes a sixth group of components comprising a counterweight 198 and one or more casters 153. Depending on the structure of the drive wheels 102 of the drive module 30, the casters 153 of the trailing module 70 may be fixed casters or swivel casters. Because the trailing module 70 is connected to the control module 32 opposite the drive module 30, the counterweight 198 offsets a weight of the first battery module 26 and balances the support housing 34 of the modular configurable automated guided vehicle 20 about the drive wheels 102 of the drive module 30.

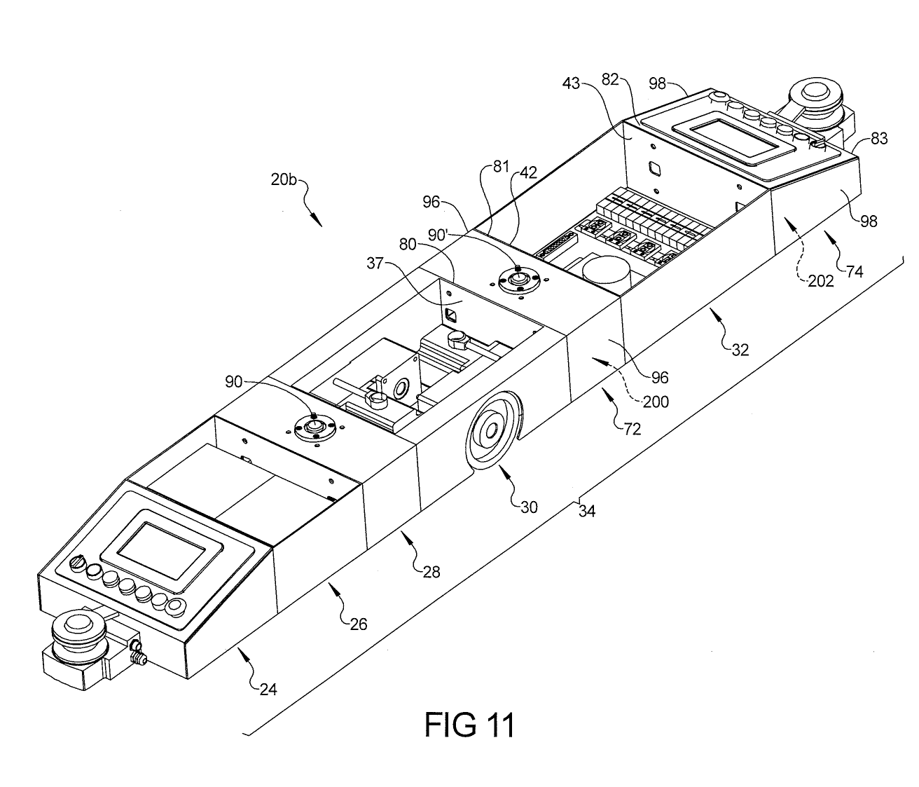

With reference to FIG. 11, another configuration of the modular configurable automated guided vehicle 20b is illustrated where a second pin module 72 and a second cowl module 74 have been added to the modular configurable automated guided vehicle 20 shown in FIGS. 1-9. The second pin module 72 may have forward and aft second pin module bulkheads 80, 81 that are longitudinally spaced apart from one another by second pin module sides 96. The forward and aft second pin module bulkheads 80, 81 and the second pin module sides 96 therefore define a second pin module compartment 200 therein. The second pin module 72 is arranged sequentially between the drive module 30 and the control module 32. In other words, the forward second pin module bulkhead 80 is connected to the aft drive module bulkhead 37 in a longitudinally abutting relationship and the aft second pin module bulkhead 81 is connected to the forward control module bulkhead 42 in a longitudinally abutting relationship. The second pin module 72 includes another set of the third group of components, which include another pin 90′. The second cowl module 74 may have forward and aft second cowl module bulkheads 82, 83 that are longitudinally spaced apart from one another by second cowl module sides 98. The forward and aft second cowl module bulkheads 82, 83 and the second cowl module sides 98 therefore define a second cowl module compartment 202 therein. The second cowl module 74 is connected to the control module 32 opposite the drive module 30 such that the first cowl module 24 faces forward when the drive wheels 102 of the drive module 30 move the support housing 34 of the modular configurable automated guided vehicle 20 in the forward direction and the second cowl module 74 faces forward when the drive wheels 102 of the drive module 30 move the support housing 34 of the modular configurable automated guided vehicle 20 in the reverse direction. In other words, the forward second cowl module bulkhead 82 is connected to the aft control module bulkhead 43 in a longitudinally abutting relationship. The second cowl module 74 includes another set of the fourth group of components. In accordance with this configuration, the modular configurable automated guided vehicle 20b is designed to operate in both the forward and reverse directions such that the modular configurable automated guided vehicle 20b does not have to turn around to switch directions.

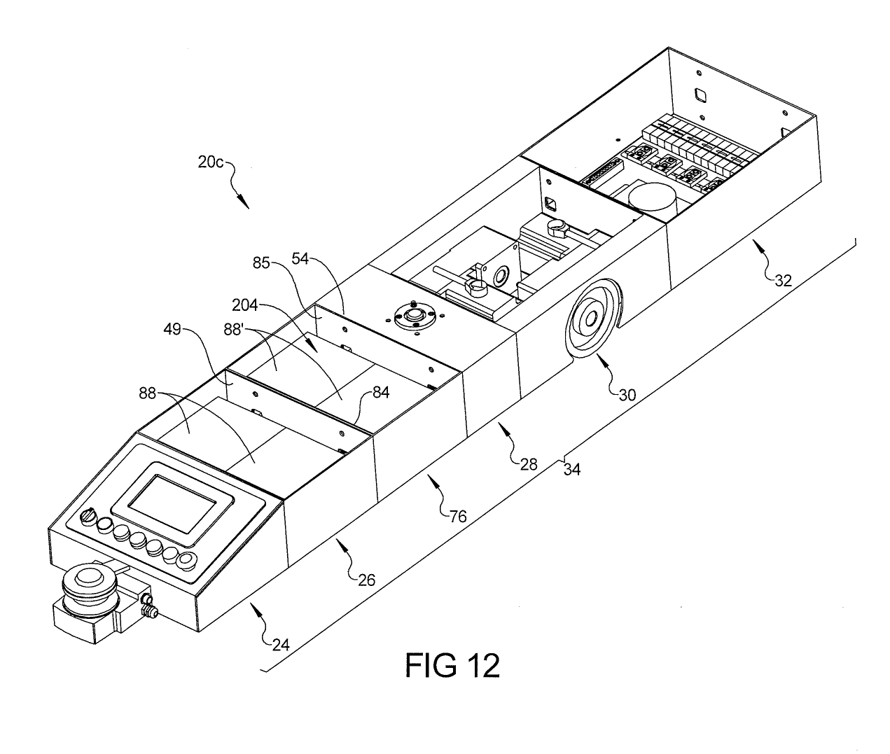

With reference to FIG. 12, another configuration of the modular configurable automated guided vehicle 20c is illustrated where a second battery module 76 has been added to the modular configurable automated guided vehicle 20 shown in FIGS. 1-9. The second battery module 76 may have forward and aft second battery module bulkheads 84, 85 that are longitudinally spaced apart from one another by second battery module sides 100. The forward and aft second battery module bulkheads 84, 85 and the second battery module sides 100 therefore define a second battery module compartment 204 therein. The second battery module 76 is positioned in an end-to-end abutting relationship with the first battery module 26. As such, the second battery module 76 may be sequentially arranged between the first battery module 26 and the first pin module 28 (FIG. 12) or between the first battery module 26 and the first cowl module 24 (not shown). In FIG. 12, the forward second battery module bulkhead 84 is connected to the aft first battery module bulkhead 49 in a longitudinally abutting relationship and the aft second battery module bulkhead 85 is connected to the forward first pin module bulkhead 54 in a longitudinally abutting relationship. Alternatively, the forward second battery module bulkhead 84 may be connected to the aft first cowl module bulkhead 61 in a longitudinally abutting relationship and the aft second battery module bulkhead 85 may be connected to the forward first battery module bulkhead 48 in a longitudinally abutting relationship (not shown). The second battery module 76 includes another set of the second group of components, which include an additional battery 88′ or group of additional batteries 88′. It should be appreciated that in accordance with this configuration, the number of batteries 88, 88′ that the support housing 34 of the modular configurable automated guided vehicle 20c can carry is double. As a result, the operating range and run time of the modular configurable automated guided vehicle 20c is doubled such that the modular configurable automated guided vehicle 20c can operate with fewer stops for re-charging.

Obviously, many modifications and variations of the present invention are possible in light of the above teachings and may be practiced otherwise than as specifically described while within the scope of the appended claims. These antecedent recitations should be interpreted to cover any combination in which the inventive novelty exercises its utility. The use of the word “said” in the apparatus claims refers to an antecedent that is a positive recitation meant to be included in the coverage of the claims whereas the word “the” precedes a word not meant to be included in the coverage of the claims. In addition, the reference numerals in the claims are merely for convenience and are not to be read in any way as limiting.

What is claimed is:

1. A modular configurable automated guided vehicle comprising:
a drive module including a drive wheel and a motor;
a first battery module including a battery;
a first pin module including a pin and a pin actuator;
a first cowl module including a bumper and a caster; and
a control module including a subplate having a plurality of electrical components mounted thereon;
wherein said drive module, said first battery module, said first pin module, said first cowl module, and said control module are discrete pre-assembled units that mate with one another in an abutting relationship to cooperatively form a support housing such that said drive module, said first battery module, said first pin module, said first cowl module, and said control module are easily replaced and are configured to be connected to one another in a variety of different customizable sequences.

2. The modular configurable automated guided vehicle as set forth in claim 1 wherein said first battery module is arranged sequentially between said first cowl module and said first pin module, said first pin module is arranged sequentially between said first battery module and said drive module, and said drive module is arranged sequentially between said first pin module and said control module.

3. The modular configurable automated guided vehicle as set forth in claim 2 further comprising:
a trailing module including a counterweight and a caster, where said trailing module is connected to said control module opposite said drive module such that said counterweight offsets a weight of said first battery module and balances said support housing about said drive wheel of said drive module.

4. The modular configurable automated guided vehicle as set forth in claim 2 further comprising:
a second cowl module including a bumper and a caster, said second cowl module connected to said control module opposite said drive module such that said first cowl module faces forward when said drive module moves said support housing in a forward direction and said second cowl module faces forward when said drive module moves said support housing in a reverse direction that is opposite said forward direction.

5. The modular configurable automated guided vehicle as set forth in claim 2 further comprising:
a second pin module including a pin and a pin actuator, where said second pin module is arranged sequentially between said drive module and said control module.

6. The modular configurable automated guided vehicle as set forth in claim 2 further comprising:
a second battery module including an additional battery, where said second battery module is positioned in an end-to-end abutting relationship with said first battery module.

7. A modular configurable automated guided vehicle for transporting a load frame on a support surface, said modular configurable automated guided vehicle comprising:
a drive module including a first group of components comprising a drive wheel, an axle, a motor, and a drive module wiring harness;
a first battery module including a second group of components comprising a battery, a battery connector, and a battery module wiring harness;
a first pin module including a third group of components comprising a pin, a pin actuator, and a pin module wiring harness;
a first cowl module including a fourth group of components comprising a collision detection assembly, a bumper, a cowl module wiring harness, a caster, and a microcontroller having a graphic user interface, a processor, and memory; and
a control module including a fifth group of components comprising a subplate having a plurality of electrical components mounted thereon and a control module wiring harness;
wherein said plurality of electrical components includes a control relay, a pin motor relay, a circuit breaker bus, a circuit breaker, a ground bus, and a motor controller;
wherein said drive module wiring harness, said battery module wiring harness, said pin module wiring harness, and said cowl module wiring harness are electrically connected to said control module wiring harness;
wherein said drive module, said first battery module, said first pin module, said first cowl module, and said control module are discrete pre-assembled units that mate with one another in a longitudinally abutting relationship to cooperatively form a support housing such that said drive module, said first battery module, said first pin module, said first cowl module, and said control module are easily replaced and are configured to be connected to one another in a variety of different customizable sequences.

8. The modular configurable automated guided vehicle as set forth in claim 7 wherein said first battery module is arranged sequentially between said first cowl module and said first pin module, said first pin module is arranged sequentially between said first battery module and said drive module, and said drive module is arranged sequentially between said first pin module and said control module.

9. The modular configurable automated guided vehicle as set forth in claim 8 further comprising:
a trailing module including a sixth group of components comprising a counterweight and a caster, where said trailing module is connected to said control module opposite said drive module such that said counterweight offsets a weight of said first battery module and balances said support housing about said drive wheel of said drive module.

10. The modular configurable automated guided vehicle as set forth in claim 8 further comprising:
a second cowl module including another set of said fourth group of components, where said second cowl module is connected to said control module opposite said drive module such that said first cowl module faces forward when rotation of said a drive wheel of said drive module moves said support housing in a forward direction and said second cowl module faces forward when rotation of said a drive wheel of said drive module moves said support housing in a reverse direction that is opposite said forward direction.

11. The modular configurable automated guided vehicle as set forth in claim 8 further comprising:
a second pin module including another set of said third group of components, where said second pin module is arranged sequentially between said drive module and said control module.

12. The modular configurable automated guided vehicle as set forth in claim 8 further comprising:
a second battery module including another set of said second group of components, where said second battery module is arranged sequentially between said first battery module and said first pin module.

13. The modular configurable automated guided vehicle as set forth in claim 7 wherein said first group of components of said drive module further includes a brake assembly, a traction spring assembly, and a gearbox, where said traction spring assembly moveably supports said drive wheel on said drive module, said drive wheel is rotatably coupled to said axle, said axle is rotatably coupled to said brake assembly and said gearbox, said gearbox is rotatably coupled to said motor, and said motor is electrically connected to said drive module wiring harness.

14. The modular configurable automated guided vehicle as set forth in claim 7 wherein said first group of components of said drive module further includes a recovery wheel and a recovery wheel deployment mechanism, where said recovery wheel is a caster and said recovery wheel deployment mechanism is operable to pivot said recovery wheel relative to said drive module and lift said drive module to a recovery position where said drive wheel no longer contacts the support surface.

15. The modular configurable automated guided vehicle as set forth in claim 7 wherein said first group of components of said drive module further includes a charge plate, where said charge plate is configured to contact and form an electrical charging connection with a remote charging station, and where said a charge plate is electrically connected to said drive module wiring harness and said drive module wiring harness is electrically connected to said battery module wiring harness such that electricity is transferred from said a charge plate, through said drive module wiring harness and said battery module wiring harness, and to said battery of said first battery module when the electrical charging connection between said charge plate and the remote charging station is established.

16. The modular configurable automated guided vehicle as set forth in claim 7 wherein said second group of components of said first battery module further includes an auxiliary charge port, where said battery is electrically connected to said battery module wiring harness at said battery connector, said battery is operable to provide electricity to said control module via said battery module wiring harness, said auxiliary charge port is electrically connected to said battery module wiring harness, and said auxiliary charge port is operable to connect with an external power line and charge said battery.

17. The modular configurable automated guided vehicle as set forth in claim 7 wherein said third group of components of said first pin module further includes a bearing assembly and a pin support frame, where said pin is slidingly supported by said bearing assembly for linear movement between a retracted position and an extended position, said pin actuator is operable to drive said linear movement of said pin, said pin is operable to engage the load frame in said extended position, said pin actuator is electrically connected to said pin module wiring harness, and said bearing assembly and said pin actuator are attached to and supported on said first pin module by said pin support frame.

18. The modular configurable automated guided vehicle as set forth in claim 7 wherein said collision detection assembly of said fourth group of components includes a laser sensor mounted to said first cowl module that is operable to detect foreign objects adjacent said first cowl module, where said bumper of said fourth group of components extends outwardly from said first cowl module and about said collision detection assembly, and where said cowl module wiring harness is electrically connected to said laser sensor and said microcontroller.

19. The modular configurable automated guided vehicle as set forth in claim 7 wherein said plurality of electrical components further includes a timer relay, a safety relay, and a pre-charge resistor.

20. The modular configurable automated guided vehicle as set forth in claim 7 wherein said drive module wiring harness, said battery module wiring harness, said pin module wiring harness, and said cowl module wiring harness have unique pin connectors, each having a unique number of pins to improve ease of assembly and eliminate electrical wiring errors.

21. A modular configurable automated guided vehicle for towing a load frame on a support surface, said modular configurable automated guided vehicle comprising:
a drive module including forward and aft drive module bulkheads that are longitudinally spaced apart from one another by drive module sides, said forward and aft drive module bulkheads and said drive module sides defining a drive module compartment therein;
a control module including forward and aft control module bulkheads that are longitudinally spaced apart from one another by control module sides, said forward and aft control module bulkheads and said control module sides defining a control module compartment therein;
a first battery module including forward and aft first battery module bulkheads that are longitudinally spaced apart from one another by first battery module sides, said forward and aft first battery module bulkheads and said first battery module sides defining a first battery module compartment therein;
a first pin module including forward and aft first pin module bulkheads that are longitudinally spaced apart from one another by first pin module sides, said forward and aft first pin module bulkheads and said first pin module sides defining a first pin module compartment therein; and
a first cowl module including forward and aft first cowl module bulkheads that are longitudinally spaced apart from one another by first cowl module sides, said forward and aft first cowl module bulkheads and said first cowl module sides defining a first cowl module compartment therein;
wherein said drive module, said control module, said first battery module, said first pin module, and said first cowl module are discrete pre-assembled units that cooperatively form a support housing;
said drive module including a first group of components comprising a drive wheel, an axle, a motor, and a drive module wiring harness;
said first battery module including a second group of components comprising a battery, a battery connector, and a battery module wiring harness;
said first pin module including a third group of components comprising a pin, a pin actuator, and a pin module wiring harness;
said first cowl module including a fourth group of components comprising a collision detection assembly, a bumper, a cowl module wiring harness, a caster, and a microcontroller having a graphic user interface, a processor, and memory;
said control module including a fifth group of components comprising a subplate having a plurality of electrical components mounted thereon and a control module wiring harness electrically connected to said subplate;
wherein said plurality of electrical components includes a control relay, a pin motor relay, a circuit breaker bus, a circuit breaker, a ground bus, and a motor controller;
wherein said drive module wiring harness, said battery module wiring harness, said pin module wiring harness, and said cowl module wiring harness are electrically connected to said control module wiring harness;
wherein said aft first cowl module bulkhead, said forward and aft first battery module bulkheads, said forward and aft first pin module bulkheads, said forward and aft drive module bulkheads, and said forward control module bulkhead have substantially identical shapes and dimensions and have fastening holes and wire routing openings that are substantially identical in size, shape, and position such that said drive module, said control module, said first battery module, said first pin module, and said first cowl module mate with one another in a longitudinally abutting relationship, are easily replaced, and are configured to be connected to one another in a variety of different customizable arrangements.

22. The modular configurable automated guided vehicle as set forth in claim 21 wherein said aft first cowl module bulkhead is aligned with and attached to said forward first battery module bulkhead in a longitudinally abutting relationship, said aft first battery module bulkhead is aligned with and attached to said forward first pin module bulkhead in a longitudinally abutting relationship, said aft first pin module bulkhead is aligned with and attached to said forward drive module bulkhead in a longitudinally abutting relationship, and said aft drive module bulkhead is aligned with and attached to said forward control module bulkhead in a longitudinally abutting relationship such that said first battery module is arranged sequentially between said first cowl module and said first pin module, said first pin module is arranged sequentially between said first battery module and said drive module, and said drive module is arranged sequentially between said first pin module and said control module.
